(19) United States
(12) Patent Application Publication
(10) Pub. No.: US 2011/0168013 A1
(43) Pub. Date: Jul. 14, 2011

(54) PISTON ASSEMBLY

(76) Inventor: Andrew Meff, Aberdeenshire (GB)

(21) Appl. No.: 12/743,422

(22) PCT Filed: Dec. 1, 2008
(86) PCT No.: PCT/GB2008/003977

§ 371 Date: Dec. 15, 2010

(30) Foreign Application Priority Data
Dec. 6, 2007 (GB) 0723822.3

(51) Int. Cl. F15B 15/26

(52) U.S. Cl. 92/27

(57) ABSTRACT

A piston assembly (10) comprises a fluid actuated piston (14) mounted within a cylinder (12), and a fluid actuated locking mechanism (16) mounted within the cylinder (12) for selectively locking the piston (14) relative to the cylinder (12). In one arrangement, the piston (14) and locking mechanism (16) are actuated by fluid supplied via a common fluid port (48).

### FIELD OF THE INVENTION

The present invention relates to a piston assembly, and in particular to a piston assembly incorporating a locking arrangement.

### BACKGROUND TO THE INVENTION

Piston assemblies incorporating a piston slidably mounted within a cylinder are well known for use in providing a driving force, for example to translate an object, wherein the stroke of the piston within the cylinder determines the positioning of the object. Such piston assemblies may be pneumatically or hydraulically actuated and the position of an object may be controlled by appropriate pneumatic or hydraulic control. In many applications an object will need to be held stationary, and this may be achieved by appropriate pneumatic or hydraulic control. However, such control may be complex to achieve, especially when the piston is biased in a particular stroking direction, for example when the piston extends into a pressure vessel or the like. In such circumstances, if piston fluid control is lost or compromised, a fluid pressure differential may be established which may cause the piston to stroke undesirably.

### SUMMARY OF THE INVENTION

According to a first aspect of the present invention, there is provided a piston assembly comprising:

a cylinder;

a fluid actuated piston mounted within the cylinder; and

a fluid actuated locking mechanism mounted within the cylinder for selectively locking the piston relative to the cylinder.

The piston may be adapted to be stroked within the cylinder between extended and retracted positions. The piston may be fluid actuated towards one of the extended and retracted positions. In this arrangement the piston may be biased towards the other of the extended and retracted positions. For example, the piston may be biased via a spring arrangement or the like.

The piston may be fluid actuated towards both the extended and retracted positions.

The locking mechanism may be reconfigurable between locked and unlocked configurations. In embodiments of the invention the locking mechanism may be reconfigured towards the locked configuration when the piston is positioned within at least one of the extended position, retracted position, and any position therebetween.

The locking mechanism may be fluid actuated towards one of the locked and unlocked configurations. In this arrangement the locking mechanism may be biased towards the other of the locked and unlocked configurations. For example, the locking mechanism may be spring biased or the like.

The locking mechanism may be fluid actuated towards both the locked and unlocked configurations.

The cylinder may comprise a plurality of fluid ports adapted to permit fluid communication of a fluid, such as a gas or liquid, to and from the cylinder to actuate the piston and the locking mechanism. In one embodiment the piston and locking mechanism may be actuated by fluid supplied through different fluid ports in the cylinder.

In one embodiment at least one of the plurality of fluid ports may be common and adapted to provide fluid communication to actuate the piston to move in a required direction and the locking mechanism to move towards a required locking configuration. Advantageously, by providing at least one common fluid port which is used to actuate both the piston and locking mechanism the number of fluid ports may be minimised and the associated fluid control may thus be simplified.

The plurality of fluid ports may comprise a first discrete fluid port adapted to provide fluid communication to actuate the piston to move towards a required position. The plurality of fluid ports may also comprise a second discrete fluid port adapted to provide fluid communication to actuate the locking mechanism to move towards a required locking configuration.

Providing a common fluid port and first and second discrete fluid ports permits full operation of the piston and locking mechanism to be achieved with at least three fluid ports, thus simplifying the complexity of the piston assembly and of any associated fluid control apparatus or the like.

In embodiments of the invention, the piston and locking mechanism may be operated as required by selective control of fluid supplied via the plurality of fluid ports. For example, the piston may be held stationary by fluid supplied via one fluid port while the locking mechanism is actuated by fluid via a different fluid port.

The locking mechanism may comprise a latching arrangement. The locking mechanism may comprise a latch member adapted to engage a portion of the piston to lock said piston relative to the cylinder. The latch member may comprise at least one and preferably a plurality of dogs. The dogs may be radially extending dogs.

The locking mechanism may comprise a locking member adapted to lock the latch member in engagement with the piston. The locking member may be adapted to be fluid actuated to move between a locked configuration in which the locking member locks the latch member in engagement with the piston, and an unlocked configuration in which locking member releases the latch member from the piston.

The locking member may comprise a sleeve or collar adapted to circumferentially surround a portion of the piston. The sleeve may be axially moveable relative to the piston. The sleeve may be mounted on the outer surface of a portion of the piston, preferably slidably mounted. The sleeve may be adapted to radially restrict the latch member when the sleeve is positioned in the locked configuration.

The sleeve may comprise first and second faces adapted to receive a fluid pressure force from fluid supplied via respective fluid ports in the cylinder. The first face may receive a pressure force from fluid supplied via a common fluid port, and the second face may receive a fluid pressure force from fluid supplied via a discrete fluid port.

The piston may comprise a profiled portion adapted to receive the latch member. The profiled portion may comprise a circumferential recess.

The piston may comprise a piston body and a piston stem extending from the piston body. The piston stem may extend from the piston body and through an orifice in the cylinder. The piston stem may comprise the profiled portion for receiving the latch member. The piston body may comprise first and second piston faces adapted to receive a fluid pressure force from fluid supplied via respective fluid ports in the cylinder. The first piston face may receive a pressure force from fluid supplied via a common fluid port, and the second piston face may receive a fluid pressure force from fluid supplied via a discrete fluid port.

The piston assembly may be adapted for use in translating an object. The piston assembly may be adapted for use in translating an object contained within a pressure vessel. In this arrangement the piston assembly may be adapted to be secured to a pressure vessel, wherein a portion of the piston extends through a wall portion of the vessel to engage the object. The piston assembly may be adapted for use subsea. For example, the piston assembly may be adapted for use in combination with a subsea tool deployment system for use in deploying tools into a wellbore. However, it will be understood by those of skill in the art that the piston assembly may be used in a number of applications.

According to a second aspect of the present invention there is provided a piston assembly comprising:

a cylinder comprising at least first, second and third fluid ports;

a piston slidably mounted within the cylinder;

a locking mechanism for selectively locking the piston relative to the cylinder,

wherein the piston is actuated by fluid supplied via the first and second fluid ports,

and wherein the locking mechanism is actuated by fluid supplied via the second and third fluid ports.

According to a third aspect of the present invention there is provided a piston assembly comprising:

a cylinder;

a piston slidably mounted within the cylinder; and

a locking mechanism mounted within the cylinder and adapted to selectively lock the piston relative to the cylinder.

The locking mechanism may be adapted to be fluid actuated. Alternatively, or additionally, the locking mechanism may be adapted to be mechanically actuated.

### BRIEF DESCRIPTION OF THE DRAWINGS

These and other aspects of the present invention will now be described, by way of example only, with reference to the accompanying drawings, in which:

FIG. 1 is a cross-sectional view of a piston assembly according to an embodiment of the present invention, wherein the piston assembly is shown in a first configuration; and

FIG. 2 is a cross-sectional view of the piston assembly of FIG. 1 shown in a second configuration.

### DETAILED DESCRIPTION OF THE DRAWINGS

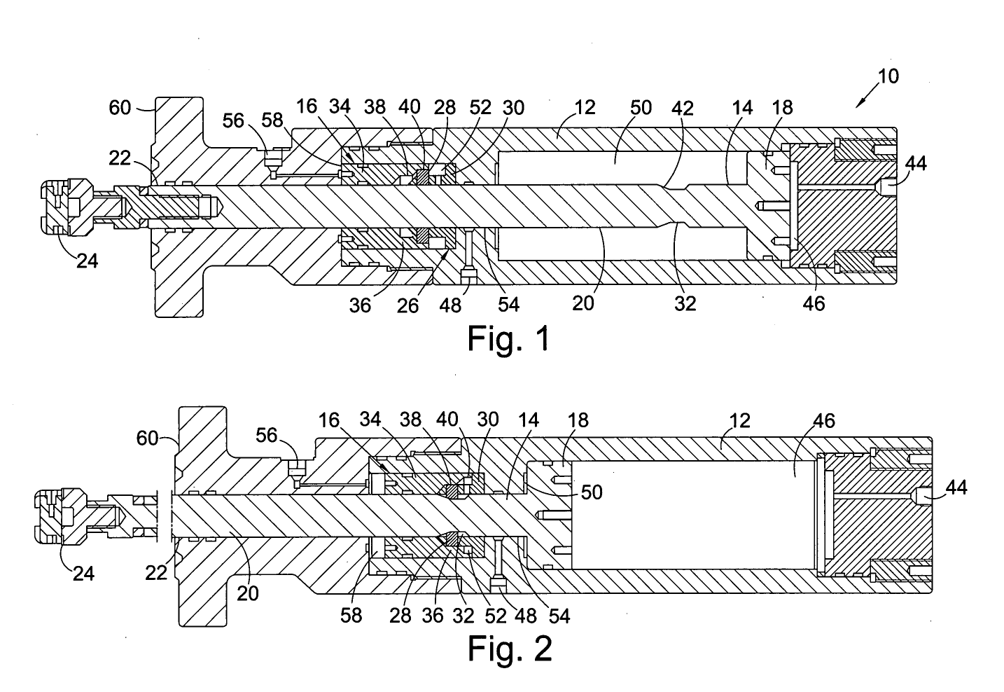

A piston assembly, generally identified by reference numeral 10, is shown in FIGS. 1 and 2, wherein FIG. 1 shows the assembly 10 in a first configuration and FIG. 2 shows the assembly 10 is a second configuration. The piston assembly 10 comprises a cylinder 12, a piston 14 slidably mounted within the cylinder 12 and a locking mechanism 16 also located within the cylinder 12. In use, the locking mechanism 16 may selectively lock the piston 14 relative to the cylinder 12, as will be discussed in further detail below. In the embodiment shown, the piston 14 and locking mechanism 16 are both fluid actuated.

The piston 14 is formed of a piston body 18 and a piston stem 20 which extends from the piston body 18 and through an orifice 22 in one end of the cylinder 12. Accordingly, a free end 24 of the stem may engage an object or the like to receive a driving force from the piston assembly 10.

The piston 14, in use, may be stroked between a retracted position, as shown in FIG. 1, and an extended position, as shown in FIG. 2. Additionally, the locking mechanism 16 may be reconfigured between an unlocked configuration, as shown in FIG. 1, and a locked configuration, as shown in FIG. 2. In the embodiment shown, the locking mechanism 16 may be reconfigured into the locked configuration to lock the piston 14 in its extended position.

The locking mechanism 16 comprises a latch member 26 which includes a plurality of radial dogs 28 supported within a retaining ring 30 which is mounted around the piston stem 20. The piston stem 20 comprises a circumferential recess 32 adapted to receive the radial dogs 28 when the recess is aligned therewith, as shown in FIG. 2.

The locking mechanism 16 further comprises a locking member in the form of a locking sleeve 34 which is axially slidably mounted on the piston stem 20. The locking sleeve 34 may be actuated to slide axially relative to the piston stem 20 to selectively lock and release the dogs 28 within the recess 32 in the piston stem 20, as will be described in further detail below.

The locking sleeve 34 comprises an internal stepped profile 36 at one side thereof, wherein the stepped profile 36 surrounds the dogs 28. When the dogs 28 are located within the recess 32 in the piston stem 20, as shown in FIG. 2, the locking sleeve 34 may be axially translated by fluid pressure such that a reduced diameter region 38 of the stepped profile 36 surrounds the dogs 28, thus radially constraining the dogs 28 within the recess 32 and locking the piston 14 relative to the cylinder 12. When the piston 14 is to be released, the locking sleeve 34 may be axially translated by fluid pressure such that an increased diameter region 40 of the stepped profile 36 surrounds the dogs 28 such that the dogs 28 are no longer radially constrained. The piston 14 may then be stroked towards the retracted position, wherein a ramped region 42 of the recess 32 radially displaces the dogs 28 which then become retained between the outer surface of the piston stem 20 and the increased diameter region 40 of the locking sleeve 34.

The cylinder 12 comprises a first fluid port 44 adapted to permit fluid communication to a first chamber 46 to actuate the piton 14 to move towards the extended position.

The cylinder 12 also comprises a second fluid port 48 adapted to permit fluid communication to a second chamber 50 to actuate the piston 14 to move towards the retracted position, and to a third chamber 52 to actuate the locking sleeve 34 to move towards an unlocked configuration. Fluid communication between the second fluid port 48 and the second and third chambers 50, 52 is achieved via an annular flow channel 54 formed between an outer surface of the stem 20 and an inner surface of the casing 12. Accordingly, the present invention permits both the piston 14 and locking mechanism 16 to be actuated towards a required direction or configuration via a single fluid port, thus advantageously minimising the number of required ports and simplifying the associated fluid control apparatus.

The cylinder 12 further comprises a third fluid port 56 adapted to permit fluid communication to a fourth chamber 58 to actuate the locking sleeve 34 to move towards a locked configuration.

One operation cycle of the piston assembly 10 will now be described, assuming the piston 14 is initially arranged in the retracted position, as shown in FIG. 1.

Fluid communicated into the first chamber 46 via the first fluid port 44 will apply a fluid force against the piston body 18, causing the piston 14 to be stroked towards the extended position, as shown in FIG. 2, and aligning the radial dogs 28 with the recess 32. Fluid may then be communicated into the fourth chamber 58 via the third port 56 to cause the locking sleeve to stroke towards its locking configuration and thus displace the dogs 28 radially into the recess 32 by interengagement with the stepped profile 36 of the sleeve 34. In this configuration the piston 14 will be locked in the extended position.

When the piston 14 is to be retracted, the first chamber 46 is pressurised by fluid supplied via the first port 44 to hold the piston 14 in the extended position. Following this, fluid may be supplied through the second fluid port 48 and into the second and third chambers 50, 52. The fluid within the third chamber 52 will therefore act against the locking sleeve 34 to move said sleeve 34 towards the unlocked configuration, thus freeing the dogs 28. It should be noted that although fluid pressure will also be acting against the piston body 18 to force the piston 14 towards the retracted position, the fluid pressure within the first chamber 46 will prevent any net movement of the piston 14.

Once the locking sleeve 34 is positioned within the unlocked configuration, fluid pressure within the first chamber 46 may be relieved and continued supply of fluid into the second fluid chamber 50 via the second port 48 will cause the piston 14 to be displaced towards the retracted position.

In one use of the piston assembly 10 of the present invention, the cylinder 12 may be secured to a pressure vessel (not shown) via a flange connector 60 and the piton stem 20 may extend into the pressure vessel. The free end 24 of the piston stem 20 may be coupled to an object (not shown) contained within the pressure vessel to thus permit the object to be moved by the piston assembly. The object may be, for example, a tool or the like.

It should be understood that the embodiment described herein is merely exemplary and that various modifications may be made thereto without departing from the scope of the invention. For example, the locking mechanism may be mechanically operated, for example via a motor or the like. Additionally, the piston assembly may be configured to lock the piston relative to the cylinder at any position or at any number of positions.

1. A piston assembly comprising:
a cylinder;
a fluid actuated piston mounted within the cylinder; and
a fluid actuated locking mechanism mounted within the cylinder for selectively locking the piston relative to the cylinder, wherein the locking mechanism is fluid actuated towards both locked and unlocked configurations.

2. The piston assembly according to claim 1, wherein the piston is adapted to be stroked within the cylinder between extended and retracted positions.

3. (canceled)

4. The piston assembly according to claim 1, wherein the locking mechanism is arranged to be reconfigured towards the locked configuration when the piston is positioned within at least one of an extended position, retracted position, and any position therebetween.

5. The piston assembly according to claim 1, wherein the cylinder comprises a plurality of fluid ports adapted to permit fluid communication of a fluid to and from the cylinder to actuate the piston and the locking mechanism.

6. The piston assembly according to claim 5, wherein at least one of the plurality of fluid ports is common and adapted to provide fluid communication to actuate the piston to move in a required direction and the locking mechanism to move towards a required locking configuration.

7. The piston assembly according to claim 5, wherein the plurality of fluid ports comprises a first discrete fluid port adapted to provide fluid communication to actuate the piston to move towards a required position.

8. The piston assembly according to claim 5, wherein the plurality of fluid ports comprises a second discrete fluid port adapted to provide fluid communication to actuate the locking mechanism to move towards a required locking configuration.

9. The piston assembly according to claim 1, comprising at least three fluid ports for operation of the piston and locking mechanism.

10. The piston assembly according to claim 1, wherein the locking mechanism comprises a latching arrangement.

11. The piston assembly according to claim 1, wherein the locking mechanism comprises a latch member adapted to engage a portion of the piston to lock said piston relative to the cylinder.

12. The piston assembly according to claim 11, wherein the latch member comprises at least one dog.

13. The piston assembly according claim 11, wherein the locking mechanism comprises a locking member adapted to lock the latch member in engagement with the piston.

14. The piston assembly according to claim 13, wherein the locking member is adapted to be fluid actuated to move between a locked configuration in which the locking member locks the latch member in engagement with the piston, and an unlocked configuration in which locking member releases the latch member from the piston.

15. The piston assembly according to claim 13, wherein the locking member comprises a sleeve adapted to circumferentially surround a portion of the piston.

16. The piston assembly according to claim 15, wherein the sleeve is axially moveable relative to the piston.

17. The piston assembly according to claim 15, wherein the sleeve is adapted to radially restrict the latch member when the sleeve is positioned in the locked configuration.

18. The piston assembly according to claim 15, wherein the sleeve comprises first and second faces adapted to receive a fluid pressure force from fluid supplied via respective fluid ports in the cylinder.

19. The piston assembly according to claim 18, wherein the first face is configured to receive a pressure force from fluid supplied via a common fluid port, and the second face is configured to receive a fluid pressure force from fluid supplied via a discrete fluid port.

20. The piston assembly according to claim 11, wherein the piston comprises a profiled portion adapted to receive the latch member.

21. The piston assembly according to claim 1, wherein the piston comprises a piston body and a piston stem extending from the piston body.

22. The piston assembly according to claim 21, wherein the piston body comprises first and second piston faces adapted to receive a fluid pressure force from fluid supplied via respective fluid ports in the cylinder.

23. The piston assembly according to claim 22, wherein the first piston face receives a pressure force from fluid supplied via a common fluid port, and the second piston face receives a fluid pressure force from fluid supplied via a discrete fluid port.

24. The piston assembly according to claim 1, adapted to be secured to a pressure vessel, wherein a portion of the piston extends through a wall portion of the vessel to engage the object.

25. A piston assembly comprising:
a cylinder comprising at least first, second and third fluid ports;
a piston slidably mounted within the cylinder;
a locking mechanism for selectively locking the piston relative to the cylinder,
wherein the piston is actuated by fluid supplied via the first and second fluid ports,
and wherein the locking mechanism is actuated by fluid supplied via the second and third fluid ports.

26. A piston assembly comprising:
a cylinder;
a piston slidably mounted within the cylinder; and
a locking mechanism mounted within the cylinder and adapted to selectively lock the piston relative to the cylinder.

27. The piston assembly according to claim 26, wherein the locking mechanism is adapted to be fluid actuated.

28. The piston assembly according to claim 26, wherein the locking mechanism is adapted to be mechanically actuated.
